(19) United States
(12) Patent Application Publication
(10) Pub. No.: US 2012/0304148 A1
(43) Pub. Date: Nov. 29, 2012

(54) VISUAL COMPARISON DISPLAY OF SOFTWARE

(75) Inventors: Michael Braun, Uehlfeld (DE); Gwendolin Knappe, Erlangen (DE); Attila Szabó, Szar (HU); Bela Balassa, Szekesfehervar (HU)

(73) Assignee: Siemens Aktiengesellschaft, Munchen (DE)

(21) Appl. No.: 13/301,140

(22) Filed: Nov. 21, 2011

(30) Foreign Application Priority Data
Nov. 22, 2010 (EP) 10014828

(51) Int. Cl. G06F 9/44

(52) U.S. Cl. 717/104

(57) ABSTRACT

In a method for comparing visual programs, a first object model is compared with a second object model, and a first difference object model and in particular a second difference object model are displayed. Differences in the programs are indicated in the difference object models by markings.

### CROSS-REFERENCES TO RELATED APPLICATIONS

This application claims the priority of European Patent Application, Serial No. EP10014828, filed Nov. 22, 2010, pursuant to 35 U.S.C. 119(a)-(d), the content of which is incorporated herein by reference in its entirety as if fully set forth herein.

### BACKGROUND OF THE INVENTION

The present invention relates to a method for displaying differences in software. The software relates in particular to a software program for open- and/or closed-loop control of an industrial process and/or of an industrial machine. Examples of processes are chemical processes, logistical processes, etc. Examples of machines are machine tools, production machinery, injection molding machines, presses, printing machines, woodworking machines, etc.

The following discussion of related art is provided to assist the reader in understanding the advantages of the invention, and is not to be construed as an admission that this related art is prior art to this invention.

In the case of programmable logic controllers and motion control systems, the user programs his own programs for his application. These are loaded onto a target device where they are executed. Over the lifetime of the machine or even e.g. during commissioning of the machine, e.g. process changes may also bring about changes in the programs for the target devices (e.g. power converter, programmable logic controller (PLC), central computer). This can result in several versions of programs for the target device in question. It is therefore necessary, on the one hand, to compare the programs (i.e. the software) for changes (offline-offline comparison), and also to be able to identify differences between a stored project status and the target device (online-offline comparison).

Quoted by way of example are motion control systems in which at least one of the following forms of programming languages or methods are available to the user. These are in particular e.g.:
structured text (textual high-level language programming)
ladder diagram (graphical combinational logic)
function block diagram (graphical combinational logic)
sequential function chart, in particular motion control chart MCC (visual flowchart programming).

For comparing textual languages (particularly high-level languages), such as C, C++, Pascal, Fortran, etc., the comparison functionality is provided by comparison of programming texts. In the case of visual (graphical) programming languages, particularly for flowchart programming, no comparison functions are available.

It would therefore be desirable and advantageous to obviate prior art shortcomings and to provide improved comparison functions for visual programming languages, in particular for visual flowchart programming.

### SUMMARY OF THE INVENTION

The term visual program is to be understood as meaning a software program which is represented and/or programmed using graphical elements. Examples include visual flowchart programming, ladder diagram (LD) or function block diagram (FBD).

In such a method for comparing programs (these can be complete programs or parts thereof), a first object model is compared with a second object model, e.g. a first difference object model being produced. The first difference object model indicates differences, if any, between the first object model and the second object model on the basis of the first object model. Advantageously, a second difference object model is also displayed which indicates differences between the second object model and the first object model on the basis of the second object model, if at least one difference is present.

The term object model is to be understood as meaning, for example, a ladder diagram, a function block diagram or a flowchart. Consequently, the object model can accordingly represent a visual program.

A program sequence can be programmed and/or represented using a sequential function chart. In particular, programs in automation systems can be easily programmed visually in this way using graphical elements. Examples of automation devices which can allow such programming are:
programmable logic controllers (PLCs),
motion control systems (particularly for closed- and/or open-loop control of motion sequences),
power converters,
central computers (e.g. for printing machines), e.g. for production lines, steelworks, machine tools, packaging machines, glass forming machines, etc.

Programs can run on such devices, and are programmed for example on a graphical basis by means of an engineering system. User programs (particularly parts programs for a machine tool) of a machine tool are then used, for example, on a runtime system of the machine tool.

The sequential function chart can also be termed a flowchart. Using a graphical representation, an algorithm can be implemented in a computer program. Computer programs in the wider sense are programs which, as already described, run, for example, on processors on open-loop control devices (e.g. programmable logic controllers (PLCs)) or closed-loop control devices (e.g. motion control systems) in industrial plants. By means of the graphical representation, a sequence of operations for solving a task can be clearly described.

Possible symbols for elements in program flowcharts are described e.g. in DIN 66001. Symbols for data flowcharts are also defined there as another kind of flowchart. Program flowcharts can also be used independently of computer programs for representing processes and activities.

Another example of a flowchart is a Nassi-Shneiderman diagram (structogram). Extended flowcharts are also used for mapping object-oriented program concepts by UML. Symbols and conventions for flowcharting are known from ISO 5807 information processing.

Programs represented as a flowchart which are written in particular using a visual programming interface, i.e. which are already present in the sense of a flowchart, constitute an object model. It is also possible for programs to be textually created and then represented graphically in a flowchart. A program written in LD (ladder diagram) or FBD (function block diagram) can also be described in a flowchart.

Such programs are translated into machine language. Elements of the chart can be e.g. ovals, rectangles, rhombi, etc. which describe particular functions. In accordance with DIN 66001, for example, start points, stop points, and other boundary points are described by an oval. Arrows and lines indicate a connection to the next element. A rectangle represents an operation, a rectangle with double vertical lines indicating a subroutine call. A rhombus is used to describe a branch, thereby symbolizing a true/false test. Inputs and outputs can be represented, for example, as a parallelogram. In addition to the start elements, stop elements, boundary point elements, operation elements, elements for invoking or servicing one or more subroutines, branch elements, input or output elements, even more elements can be implemented in a flowchart.

It is important for an automation system user, e.g. an operator or programmer, to be easily able to identify and/or program the program sequence graphically. It is also important for the user to be able to detect or analyze changes e.g. to an old version of a program.

An automation system has, for example, a facility for parameterizing, configuring and/or commissioning control systems and/or for creating preferably cyclical control programs using a visual editor device for editing a control program. An engineering system can be used for this purpose. Said engineering system can, for example, carry out a comparison of object models. Alternatively or additionally, a runtime system can also be used for comparing object models.

Differences between the object models can be represented by various graphical measures. The visual appearance of elements and connections between elements can be changed e.g. by one or more of the following measures:

changing the color for an element;

changing a line width for an element;

changing the gray scale value for an element;

changing the labeling for an element;

changing the color saturation for an element;

flashing of an element;

etc.

By means of the visually based comparison of programs, wherein a first object model (in particular a first flowchart) is compared with a second object model (in particular a second flowchart), simple graphical detail comparison of flowchart programming elements is achieved. It is thereby also possible to compare graphical combinational logics with one another.

According to one aspect of the invention for comparing visual programs, the first object model is compared with the second object model, and a first and second difference object model are created. The difference object models indicate how the first object model differs from the second object model and vice versa.

According to one advantageous feature of the invention, to compare the object models the first object model is combined with the second object model to produce an aggregate model. This aggregate model (aggregate object model) can, but need not, be displayed to a user. At least one of the object models is compared with the aggregate model, wherein differences between aggregate model and at least one of the object models are displayed in the respective difference object model. In the first difference object model, the differences between the aggregate model and the first object model are displayed. In the second difference object model, the differences between the aggregate model and the second object model are displayed.

According to one advantageous feature of the invention, the first object model is compared with the aggregate model. The first object model is displayed with the differences with respect to the aggregate model in the first difference object model. The second object model is also compared with the aggregate model and displayed with the differences with respect to the aggregate model in the second difference object model. Said differences are in particular color-highlighted, the first and second difference object model being advantageously displayed simultaneously side by side on a screen.

According to one advantageous feature of the invention, the difference object models are juxtaposed such that identical or similar elements of the first and second object model are displayed vertically or horizontally at the same height in the two difference object models. This makes the models particularly easy to compare. Elements of the difference object model that do not differ from the initial object model will advantageously not be highlighted.

According to one advantageous feature of the invention, similarities between the first object model and the second object model are displayed in the difference object models.

According to one advantageous feature of the invention, a missing element and/or an additional element is displayed or marked, as the case may be, in the first difference object model and/or in the second difference object model.

According to one advantageous feature of the invention, a difference object model exhibits at least one of the following differences between the object models:

an additional element,

a missing element,

an additional connection,

a missing connection,

an identical parameterization of an element,

a different parameterization of an element, and/or

a different version of an element.

According to one advantageous feature of the invention, the first object model is compared with the second object model such that first XML data is generated from the first object model, that second XML data is generated from the second object model, and that the XML data is processed such that the processed data can be used to generate the first difference object model and the second difference object model.

The XML data also enables a representation for an aggregate model to be produced, wherein said XML data of the aggregate model is then compared with the XML data of the object models and a visual display of difference object models is again produced therefrom.

If a user wishes to compare visual programs such as ladder diagrams (LDs) and/or function block diagrams (FBDs), to this end at least one characteristic value can be determined for the programs that are to be compared. This allows the user to compare visual programs which are programmed in combinational logic quickly and with low computational complexity. The user can be shown not only structural differences in the programming but also differences in the parameterization. In a comparison, in particular the sources (LD or FBD) are juxtaposed and the differences are e.g. color-marked. In a comparison process for the visual programs LD or FBD, a first characteristic value is determined for a first program and a second characteristic value is determined for a second program. The first characteristic value of the first program can then be compared with the second characteristic value of the second program. The program in question is e.g. a complete program or only a part thereof. The programs in LD logic and FBD logic are advantageously convertible into one another. Both program types (LD and FBD) are based on a visual programming interface, or rather on a graphical means of representing the program, so that such a program can also be termed an object model. In the function block diagram, function blocks are represented which can be interlinked, the blocks representing objects which are linked to form a model of the programming. In the ladder diagram, contact blocks are graphically represented which constitute networks and in their linkage also produce a model of the programming. This likewise applies to the function block diagram.

According to one advantageous feature of the invention, a comparison can again be produced from different object models, a first object model and a second object model, such that a first difference object model and a second difference object model is generated, this taking place on the basis of a “merged” aggregate object model.

LD and FBD constitute examples of programming in a combinational logic. By forming a characteristic value for the respective programs, differences can be both detected and graphically represented simply and quickly. Through using a characteristic value, it is longer necessary for all the details of a program to be compared in order to detect whether there is a difference. Using a characteristic value for a program or for particular features of a program, it can be more quickly detected whether or not particular features of two or more programs are different.

According to one advantageous feature of the invention, a hash is used as a characteristic value. The hash, i.e. the hash value, is based on a hash function (hash value function) whose result it is. There are many different kinds of hash functions, e.g. a cryptographic hash function, as a special form of the hash function which possesses the particular characteristic of a one-way function.

A hash function is a function which can map a character string of any length to a fixed-length character string. The target set is consequently smaller than the output set of the hashed source data. Different source data results in different hash values. The hash value therefore constitutes a kind of fingerprint, as virtually unambiguous identification of a larger volume of data is possible. Hash functions differ, for example, in the definition set of their inputs, the target set of the possible outputs and in the effect of patterns and similarities of various inputs on the output, so that the type of difference can also be inferred from the different output of a hash function. As the hash value is in practice shorter than the original data structure, collisions are possible in many cases, for which reason a collision detection method may be advantageously provided. If the hash value is large enough, a collision can be prevented.

By means of the hash values calculated, differences between the programs can be identified. The differences are advantageously visualized in dedicated form. At least one of the following differences is advantageously identified:
more elements/structures are present in the first program than in the second program;
more elements/structures are present in the second program than in the first program; and/or
the same instruction is present in both programs, but is parameterized differently.

Such differences found can be e.g. reconciled directly in the display system with which they are also represented.

According to one advantageous feature of the invention for comparing the programs, the characteristic value is not formed from data of the entire program or partial program (which is also possible), but from program data to which at least one particular function is assigned. The characteristic value can be determined from at least one of the following items of function data of a program (in particular of the two programs to be compared):
connection data of the respective program (data concerning the linking of function blocks or contacts, as the case may be);
variable data of the program (data concerning variables of function blocks or contacts, as the case may be);
comment data of the respective program (data concerning comments relating to function blocks or contacts, as the case may be); and/or
declaration data of the respective program (in particular a declaration table).

Consequently, e.g. a connection hash or also a variable hash can be formed in this way.

According to one advantageous feature of the invention for comparing at least two programs, for each combinational logic network a first hash is created for the structure information (relating to the connection data) and a second hash is created for the parameterization. For the comparison, first the hashes of the program sections of the networks are now compared with one another. If there are differences between the structure hashes, another inspection takes place in respect of the program structure. In the case of differences between the parameter hashes, a parameterization comparison is performed. In both methods of this at least two-stage concept, the detailed inspection takes place in particular via a fuzzy logic section in which heuristic characteristic values are used for the comparison functionality. This heuristic inspection takes place via different paths, each providing a corresponding result count. The highest result count corresponds to the path with the highest probability of equality. The path with the highest result count is then used for preparing the visualization. In the visual representation, the differences in the networks are then displayed to the user via color identification marking. Using the hash values provides a multi-level method for comparing programs, particularly industrial automation programs.

The procedure for comparing programs created using the LD/FBD programming language can take place on a multi-level basis as follows, wherein the algorithm for a detail comparison can also be subdivided into at least three levels:
Network Level (Highest Level)
   For the parameterization and structure of a network, a hash code (hash value) is formed in each case. When comparing two programs, the structure hashes and parameter hashes are compared against one another. From this a decision is then made as to how the further stages of the detail comparison must be carried out. If the respective hashes of the programs are equal, the two networks are also identical and the network is identified as identical. If one of the two hashes is different, a jump deeper into the detail comparison takes place. The comparison is based on heuristic values for the individual elements which then provide a more detailed comparison result for the individual elements.
Device Level (Medium Level)
   In addition, in the case of inequality for one of the hashes, the devices used in the network are examined. If the devices used in the network exhibit equality or inequality, the heuristic parameters are used accordingly for result evaluation and stored. Truth values for equality at device level are derived from the pin level truth values by means of special weighted average calculations. The weights are heuristically adjusted and possibly fine-tuned subsequently. According to the degree of equality the further inspection takes place at PIN level.
Pin Level (Lowest Level)
   At pin level, simple algorithms are used for pairing the pins and for establishing the equality truth values of the pins. These algorithms depend on the type of device.

If the two hashes are not equal, as already indicated the two networks are not automatically non-identical. Therefore, at network or device level, for example, e.g. modified LCS (longest common subsequence) algorithms are combined with fuzzy logic. For the statement as to whether “A equals B”, these algorithms assign the elements so-called truth values instead of a yes/no statement. Such a truth value can assume any value between 0 and 1. A statement can therefore possess a greater or lesser truth content. The higher the truth content, the more likely the comparison result is to be equal. The purpose of the LCS algorithms is: to determine the set of disjunct “(A,B)” element pairs on both levels for which the sum of these truth values is maximum. The results are stored accordingly for the display.

In another embodiment of the method, lower limit values for the pairs are also introduced onto the two higher levels. Any element pairs for which the equality truth value falls below the lower limit value are eliminated. The lower limit values are determined heuristically.

Differences found, i.e. results of the comparison of the hash values, can be indicated using various methods. By means of an algorithm, e.g. the following can be represented:
At Network Level:
   A list of the network pairs (left/right) and the equality truth values are created for each network pair. The network pairs for which the equality truth value is less than the lower limit value are eliminated. A network is paired if the network is entered in this network pair list.
At Device Level:
   A list of the device pairs is created for each network pair of the above mentioned list, and the equality truth values are entered for each device pair. The device pairs for which the equality truth value is less than the lower limit value are eliminated. A device is paired if its network is paired and if the device is in the device pair list associated with the network pair.
At Pin Level:
   A list of the pin pairs for each device pair of the above mentioned device pair list is created. The pin pairs with interconnected pins are eliminated from these lists. A pin is paired if its device is paired and if the pin is in the pin pair list associated with the device pair.

Two programs to be compared can be displayed side by side in an editor by means of at least one of the following display variants:
Networks of two programs are displayed side by side, a first program on the left-hand side, a second program on the right-hand side of a display area;
If a network on the left-hand side is not paired, a correspondingly large gap is inserted on the right-hand side; there is no color marking in this case; the network is not present in the right-hand program;
If a network on the right-hand side is not paired, a correspondingly large gap is inserted on the left-hand side; there is no color marking in this case; the network is not present in the left-hand program;
If a network is paired, both networks are displayed left and right, and the differences present are indicated as follows:
   if the network titles are different, these are color-highlighted on both sides;
   if the network comments are different, these are color-highlighted on both sides;
   the unpaired devices are color-highlighted in the network (including their pins, headers or instance names);
   in the case of paired devices, the differences are indicated as follows:
      if the header or the instance name is different, this information is color-highlighted on both sides;
      the unpaired, unconnected pins are color-highlighted (e.g. only the value range);
   If a paired device or a paired pin is selected on one side, the pair of the selected device/pin is automatically selected; the same also applies to multiple selection.

This display method makes the differences in a network clearly identifiable to the user, particularly through color-marking of elements. Identical elements are e.g. not color-highlighted, the degree of change in the program therefore also being identifiable to the user.

According to one advantageous feature of the invention, the truth value is determined on the basis of the characteristic value, said truth value being determined in particular by means of fuzzy logic, this value also advantageously being displayed. This indicates whether a displayed difference may be false. Depending on the truth value, the user can then e.g. convert one of the programs into the other program.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a first method for comparing object models;

FIG. 2 shows a second method for comparing object models;

FIG. 3 shows a first object model;

FIG. 4 shows a second object model;

FIG. 5 shows a first comparison of two difference object models;

FIG. 6 shows a second comparison of two difference object models;

FIG. 7 shows a third comparison of two difference object models;

FIG. 8 shows a comparison for a function block diagram;

FIG. 9 shows a comparison for a ladder diagram;

FIG. 10 shows a detail representation of the networks as per FIG. 9; and

FIG. 11 shows a detail representation of difference relating to a function element.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. Where in the description of the Figures reference is made to marking by means of gray shading, this may also be replaced by corresponding hatching in the respective Figure.

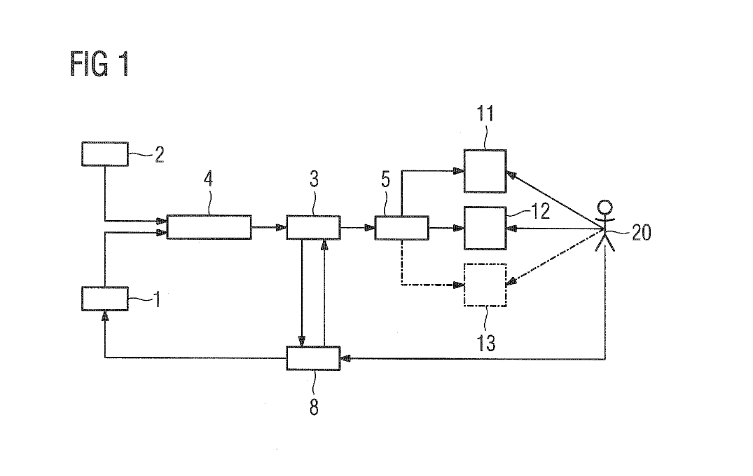

Turning now to the drawing, and in particular to FIG. 1, there is shown a first method for comparing object models. Depicted here is a first object model 1 and a second object model 2. Both object models represent a program chart, i.e. a graphics-based software program, in particular a motion control chart MCC. In a further processing step 4, the object models 1 and 2 are compared with one another by taking the MCC difference and combined into an aggregate model 3 (aggregate object model of object model 1 plus 2). The aggregate object model 3 thus generated is used to generate, by means of an MCC graphics engine 5, a first difference object model 11 on the basis of the first object model 1 and a second difference object model 12 on the basis of the second object model 2. The engine 5 can also be used to generate a representation 13 of the aggregate object model. A viewer or user 20 can view the difference object models 11 and 12 as well as the aggregate object model 13 on a visual display unit (screen). The user 20 is also able, via a correction function 8, to reconcile differences between the object models. Thus, for example, the first object model 1 can be changed by means of the information from the aggregate object model 3. The change can result in a partial or complete reconciliation of the object models 1 and 2.

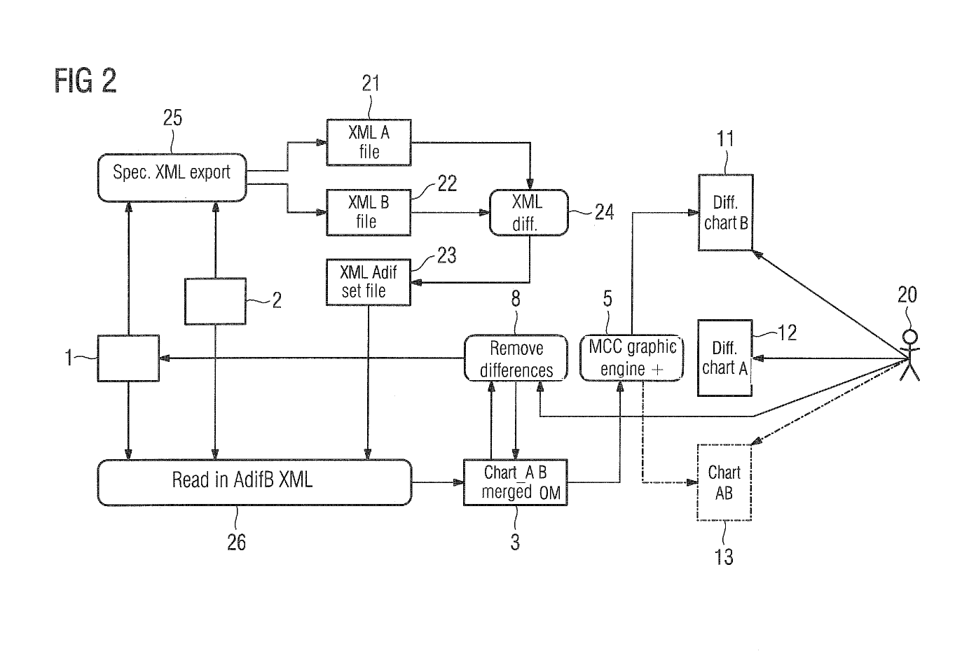

FIG. 2 illustrates another method for comparing object models, wherein a first object model 1 and a second object model 2 are depicted. Both object models represent a program chart, i.e. a graphics-based software program, in particular a motion control chart MCC. In a processing step 25, the two object models 1 and 2 are exported to XML. After this XML export 25, XML-based object models 21 and 22 are present. In a further processing step 24, the first and the second XML-based object models 1 and 2 are compared with one another by a kind of taking the difference (detecting differences) and combined into an XML-based aggregate model 23 (XML-based aggregate object model of the XML-based object models 1 plus 2). In another processing step 26, the XML-based aggregate model 23 can be merged with the object models 1 and 2 to produce an aggregate model 3. The aggregate object model 3 thus generated is used to generate, by means of an MCC graphics engine 5, a first difference object model 11 based on the first object model 1 and a second difference object model 12 based on the second object model 2. The engine 5 can also be used to generate a representation 13 of the aggregate object model. This is optional and therefore shown by a dashed line in FIG. 1 and FIG. 2. A viewer or user 20 can view the difference object models 11 and 12 as well as the aggregate object model 13 on a visual display unit (screen). The user 20 is also able, via a correction function 8, to reconcile differences between the object models. Thus, for example, the first object model 1 can be changed by means of the information from the aggregate object model 3. The change can result in a partial or complete harmonization of the object models 1 and 2.

Using one of the methods described above it is possible to compare programs, which exist on the basis of a visual flowchart, only as graphics, i.e. to display differences with respect to another program. From data relating to the graphics, the actually executable program (machine program) is constituted via a generating process, said generate hitherto offering no possibility of converting the data back to graphics in a reverse process. Using the methods described, it is now possible to compare flowcharts to be compared on the basis of the graphical information.

For example, from graphics data, a reduced description format of the graphics is generated for the comparison. Said reduced description format can, for example, contain no data as to how elements of the flowchart are to be translated into machine language. The reduced description format is generated in particular for the two object models, said object models representing flowcharts to be compared. The two reduced description formats of the graphics are then combined. This merged description format is now in turn compared with the first reduced description format and the second reduced description format and the differences are determined therefrom.

From these results, the graphics of the original programs with the differences, i.e. the difference object models 11 and 12, can now in turn be generated from the reduced descriptions and the differences. The differences can be marked in color so that the user can directly detect new, changed or deleted elements. This provides a method for comparing visual flowcharts and for displaying the differences directly in the visual program.

The differences between the object models can be visualized in a suitable and therefore dedicated form. The following differences can be typically displayed:
more elements/structures are present in the first program than in the second,
more elements/structures are present in the second program than in the first, and/or
the same instruction is present in both programs but is parameterized differently.

Differences found can optionally also be directly reconciled. The method offers the user 20 the possibility of comparing two programs with one another and color-marks the differences according to type. It is also possible to reconcile found differences accordingly.

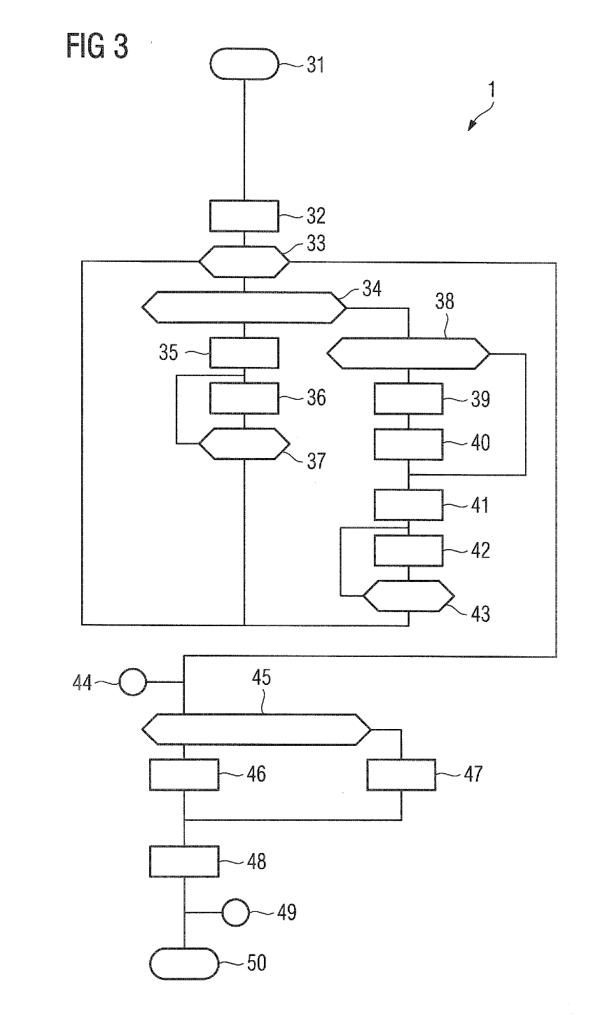

FIG. 3 depicts a first object model 1 with the elements 31 to 50 which are interconnected as shown in FIG. 3.

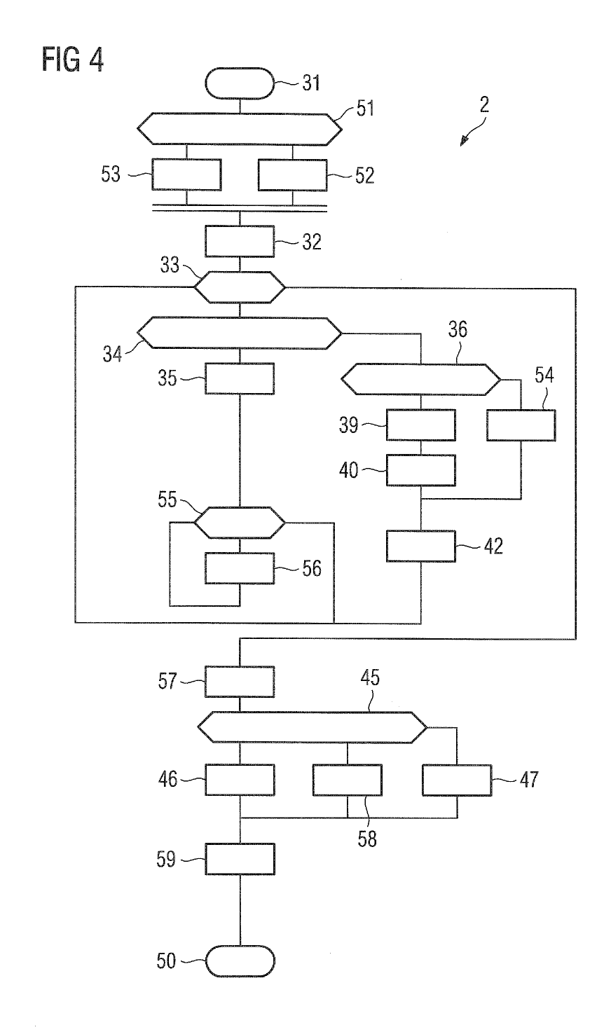

FIG. 4 depicts a second object model 2 with the elements 31 to 36, 39, 40, 42, 45 to 47 and 50 to 59 which are interconnected as shown in FIG. 4.

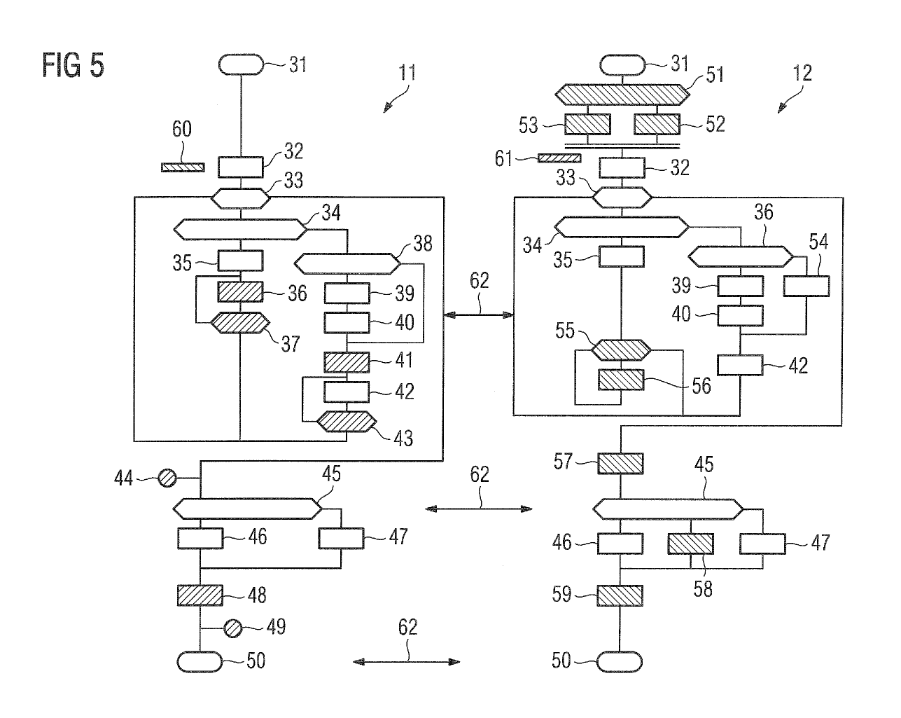

FIG. 5 depicts a first difference object model 11 with the elements 31 to 50 and 60 which are interconnected as shown in FIG. 5. Also depicted in FIG. 5 is a second difference object model 12 comprising the elements 31 to 36, 39, 40, 42, 45 to 47, 50 to 59 and 61 which are interconnected as shown in FIG. 5. The first difference object model 11 is based on the object model 1 shown in FIG. 3. The second difference object model 12 is based on the second object model 2 represented in FIG. 4. The elements by which the first object model 1 differs from the second object model 2 are marked in the first difference object model 11. The basis for the first difference object model 11 is consequently the first object model 1. The marked elements are 36, 37, 41, 43, 44, 48 and 49, as these elements of the first object model 1 are not present in the second object model 2. The marking takes the form, for example, of gray shading of the corresponding elements, as shown in FIG. 5. Not shown but also possible is color marking of the elements 36, 37, 41, 43, 44, 48 and 49 e.g. in blue. Markings in the second difference object model 12 can be implemented in the same way or also differently, e.g. in orange. Identical elements in the difference object models 11 and 12 are not marked. This relates to the elements 31 to 35, 38 to 40, 42, 45 to 47 and 50. The difference object model 11 has an additional element 60 which is also marked by gray shading and indicates, for example, that a parameter of the element 32 is different in the comparison between the object models 1 and 2.

In the second difference object model 12, the elements by which the second object model 2 differs from the first object model 1 are marked. The basis for the second difference object model 12 is consequently the second object model 2. The second object model 2 differs from the first object model 1 by the elements 51 to 53, 50, 54, 56, 57, 58 and 59 which are gray-shaded in the second difference object model 12. The difference object model 12 has an additional element 61 which is also marked by gray shading and indicates, for example, that a parameter of the element 32 is different in the comparison between the object models 2 and 1.

As shown in FIG. 5, first and second difference object model 11 and 12 can be displayed side by side such that identical elements (31 to 35, 38 to 40, 42, 45 to 47 and 50) are at the same height. In FIG. 5 a vertical comparing representation is selected, as indicated by the arrow 62.

In the FIG. 5 variant, elements which are missing in an object model are not displayed in the difference object model based on the object model where these elements are missing. In a display variant also possible which is not shown in FIG. 5, missing elements can also be indicated e.g. by means of a semi-transparent display of the missing element.

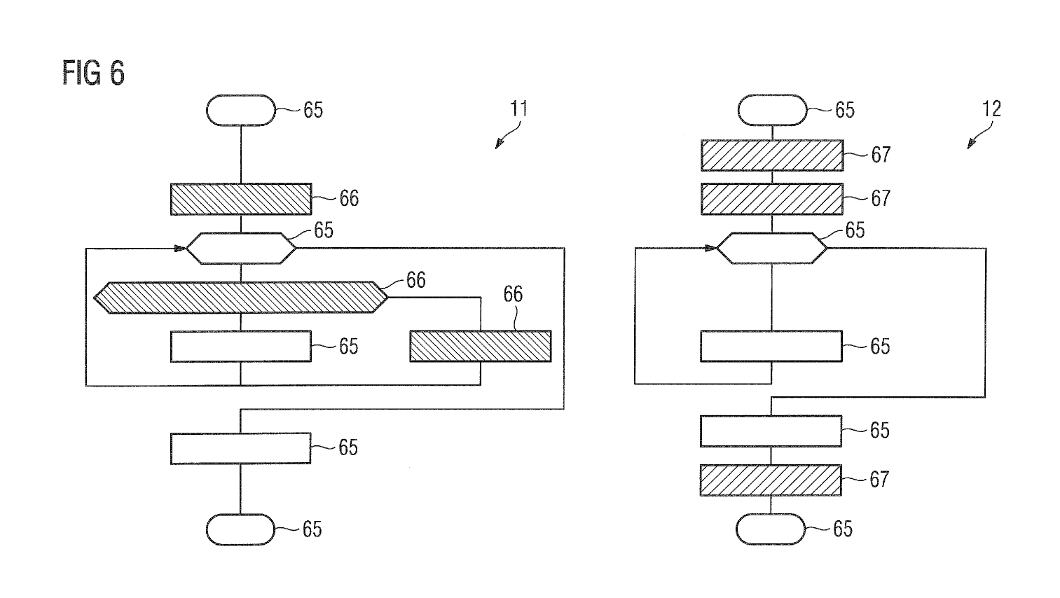

FIG. 6 depicts a second comparison of two difference object models 11 and 12. Identical elements 65 have a common representation in the different difference object models 11 and 12. In the first difference object model 11, different elements 66 have a different marking from the common elements 65. In the second difference object model 12, different elements 67 have a different marking from the common elements 65.

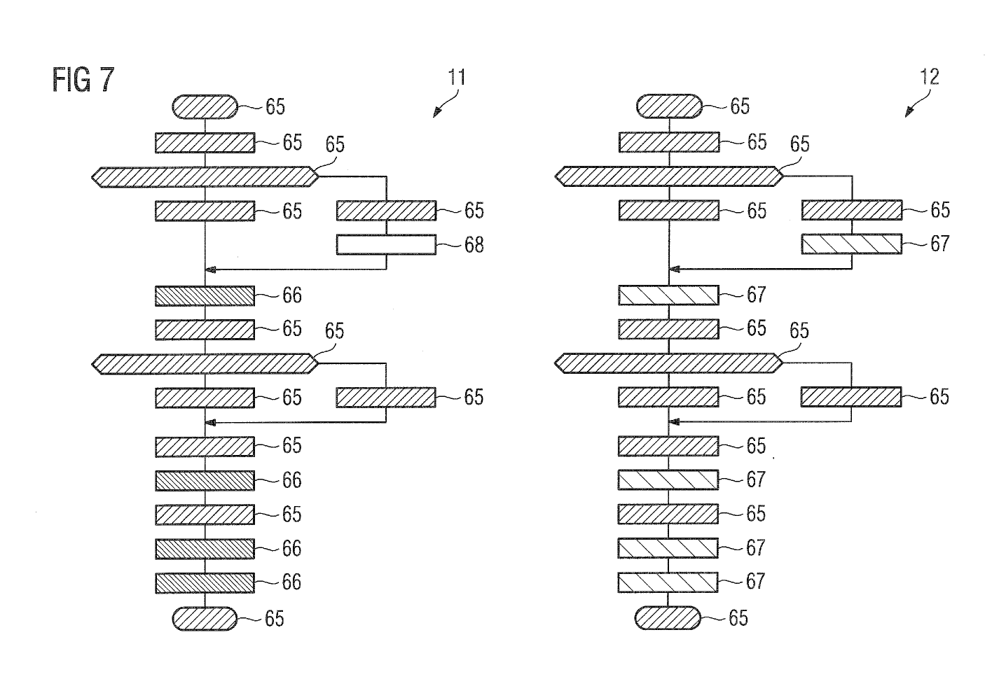

FIG. 7 shows a third comparison of two difference object models 11 and 12. Identical elements 65 again have a common representation in the different difference object models 11 and 12. In the first difference object model 11, different elements 66 have a different marking from the common elements 65. In the second difference object model 12, different elements 67 have a different marking from the common elements 65. Different elements 67 have different parameterizations. The object model on which the second difference object model 12 is based has an element which is not present in the object model on which the first difference object model 11 is based. This element 68 is specially marked in the first difference object model 11, in particular by a blank box.

In the case of motion control charts, the comparison can therefore be arranged in a similar manner, as also shown in FIGS. 3 to 7. That is to say, the programs (object models) are juxtaposed and the differences are e.g. marked in color. The graphic is adjusted on both sides so that identical or similar elements (elements with difference) appear at the same height. If elements are missing in a program, when the command is marked in one program, e.g. a blue frame is inserted on the opposite side in the other program. The user can therefore see where the command is not present in that program. Advantageously, individual elements can be taken over or all the differences at once. As differences may likewise be present within a command box (constitutes an element type), advantageously there is additionally also in the case of MCC a detail comparison of the individual command box. In the case of missing elements, the comparison is able to determine the missing elements in a chart and then expand the graphic accordingly, which means that the elements are always at the same level. The user can therefore clearly see that the structures are similar, but that elements are missing at corresponding points. For the sake of clarity, the user can mark the extra element and obtains e.g. a blue frame again at the point in the chart where the element is missing. In the case of elements of the same kind but which are different, the elements are juxtaposed. The coloring informs the user that, although the commands are similar, differences exist in the parameterization. Differences in the parameterization can be invoked e.g. by calling up (double-clicking) a detail mask.

The methodology for this comparison could also be used for other graphical representations of flowcharts. For in the comparison a derivative of the graphical representation is used by the methodology. To determine the extra or missing elements as the case may be, the two graphical representations are then merged. This result from the two charts is then used to display the expanded graphic. By determining the elements present in the individual chart for the merged representation, the elements of the individual charts are then colored accordingly in the case of differences and the elements not present are removed. However, said expansion of the graphic remains. In the visual representations of the individual charts, the result is a synchronous display of the two graphics with the corresponding differences.

By double-clicking e.g. a marked command box (element), a dialog window can be advantageously opened. In the dialog window, detail information concerning the element is displayed, with differences also being marked here, in particular colored. The user can also obtain e.g. additional information concerning the value allocation in the command. If differences are also present there, these are also color-marked. This serves to give the user decision assistance as to whether it is advisable to adopt the command.

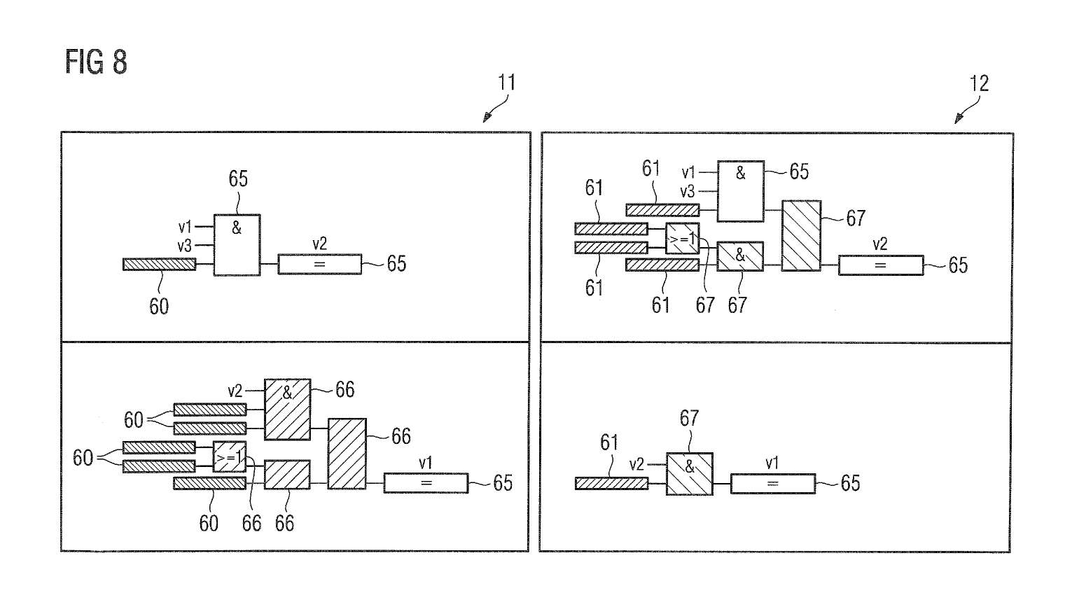

The representation according to FIG. 8 shows a function block diagram for a first program 11 and a function block diagram for a second program 12, the differences already being marked in each case. The programs 11 and 12 are therefore displayed as difference object models 11 and 12. Identical elements 65 have a common representation in the different difference object models 11 and 12. In the first difference object model 11, different elements 66 are marked differently from the common elements 65. In the second difference object model 12, different elements 67 are marked differently from the common elements 65. The markings 60 and 61 are used to indicate differences in variables. As a result, a comparison of two programs is displayed. The reference program is displayed, for example, in the representation on the left-hand side. The program compared against it is displayed on the right-hand side. The matching networks are juxtaposed and are at the same level. The differences in said networks are e.g. color-marked, which is not shown the FIG., however. The elements determined to be identical retain their normal representation. In the example, it can also be seen that by means of the new algorithms, even incompletely entered programs can be compared against one another.

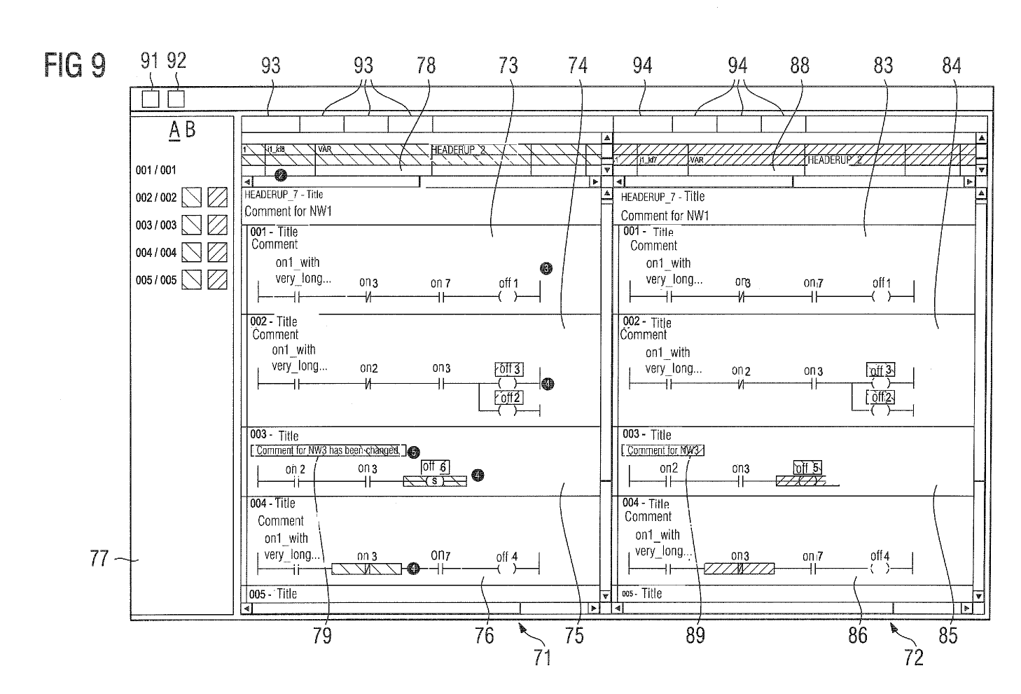

The display depicted in FIG. 9 shows a comparison of two programs which are represented as a ladder diagram. Shown here are a first ladder diagram 71 and a second ladder diagram 72. To compare these program sources, the ladder diagrams 71 and 72 are juxtaposed. Differences can be color-marked, only gray shading being shown in FIG. 9. Differences in the diagram 71 can be e.g. colored blue or left-hatched. Differences in the diagram 72 can be e.g. colored orange or yellow or right-hatched.

4 networks for each program 71 and 72 are shown. A list with network numbers is shown in a left-hand half of the image. The networks 73 and 83 have the number 001. The networks 74 and 84 have the number 002. The networks 75 and 85 have the number 003. The networks 76 and 86 have the number 004. The networks of the program 71 are marked in a column A. The networks of the program 72 are marked in a column B. If the networks of two programs do not differ, this is marked, for example, such that, as in FIG. 9, rectangles are not filled in. If differences are present, the rectangles for the corresponding network are color-marked (e.g. blue for networks of the program 71 in column A and orange or yellow for networks of the program 72 in column B. In FIG. 9, the networks 002, 003, 004 and 005 differ.

In the left-hand overview, the network numbers are therefore listed in columns A, B, it being provided that the user can jump to the difference point with a click of the mouse. In the case of large programs, this is advantageous in that the user does not need to scroll to the difference point.

Differences in the variable declaration are likewise color-marked. For this purpose a window 78 is provided for the first program 71 and a window 88 for the second program 72. If different representations are present e.g. for:

parameters/variables;

I/O symbols;

structures; and

lists

and these can be selected e.g. by tabs 93, 94, these tabs can also be color-marked if differences in the data of the respective tabs are present.

The networks 73 and 83 are identical and therefore not colored in the juxtaposition.

For displaying the differences in the networks 74 to 76 and 84 to 86, the individual elements are colored (in particular differently colored) or gray shaded. If the differences are in the variables, only these are colored or gray shaded. In the case of differences in the connection, coloring or gray shading is only provided there. If the difference applies to both, both are colored or gray shaded. This is possible by using at least 2 different hashes, thereby enabling differences in the structure and in the variables to be determined separately.

Also differences in the comments are found and colored or gray shaded accordingly, as shown in FIG. 9 for the comments 79 and 80.

Using the function buttons 91 and 92 at top left, the differences can be transferred individually or entirely from the left-hand source 71 to the right 72. Here too it is possible to jump to the next difference.

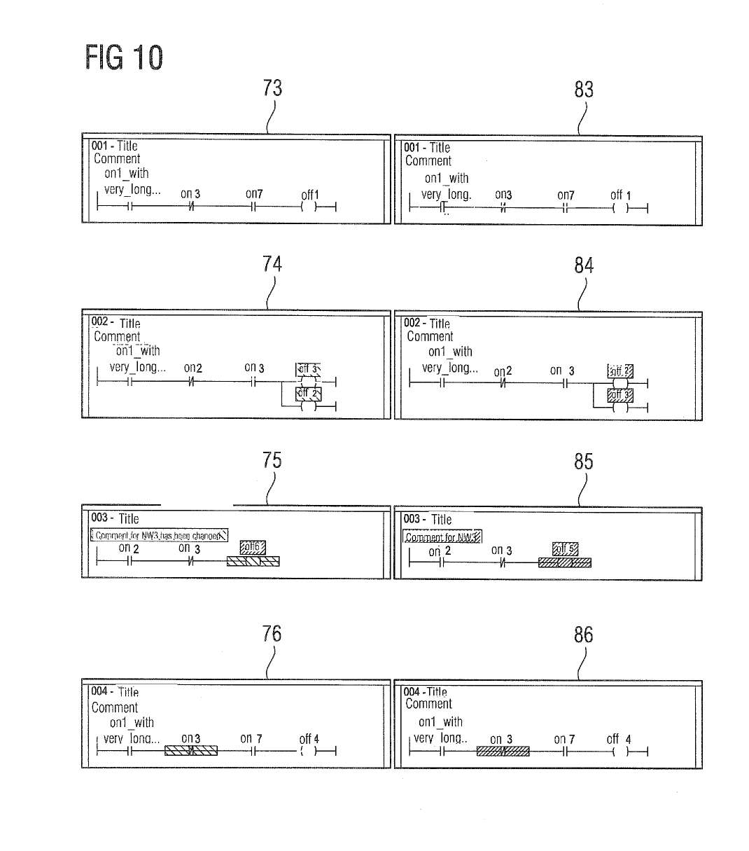

The display according to FIG. 10 shows detail views of the networks from FIG. 9.

The networks 73 and 83 are identical and are juxtaposed without coloring-in or color marking.

For the networks 74 and 84 it has been ascertained on the basis of the variable hashes that the network possesses differences in respect of the outputs. The function of the two networks is identical here, but the outputs are transposed by the programming sequence. The differences are marked.

For the networks 75 and 85 it has been ascertained that the output variable and also the function of the output is different. There is also a difference in the comment. However, the network is sufficiently similar to be juxtaposed. The differences are marked.

For the networks 76 and 86 it has been ascertained that a difference is present only in the structure hash, i.e. all the variables are identical. However, the normally closed contact has been replaced by a normally open contact. This difference is again marked.

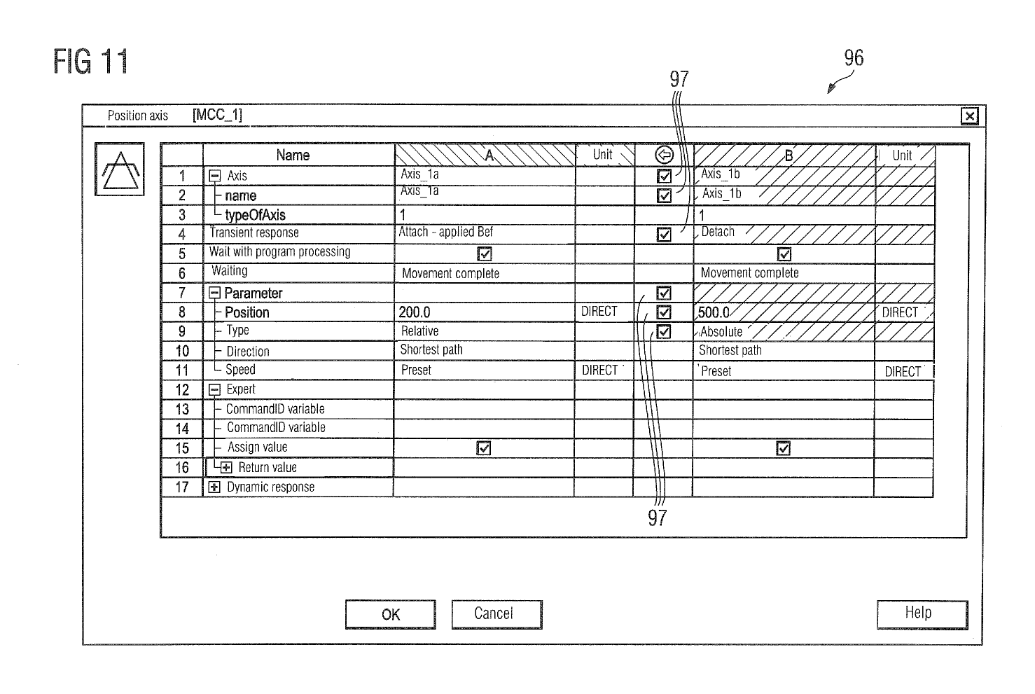

The display according to FIG. 11 shows the detail representation of differences in a functional element axis 96. By double clicking on the corresponding element e.g. in the difference object model, the element opens, color marking being used to indicate differences between two similar elements. Using dialog boxes 97 the user can decide which changes are to be transferred from one program to the other program. This is very simple, because once again the differences are color-marked. The user can also obtain additional information concerning the value assignment in the command. If differences are also present there, these are also color-marked. This helps the user to decide whether it is advisable to transfer the command.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for comparing visual programs, comprising the steps of:
comparing a first object model with a second object model, and
displaying a first difference object model.

2. The method of claim 1, and further displaying a second difference object model

3. The method of claim 2, further comprising the steps of:
combining the first object model with the second object model to produce an aggregate model,
comparing at least one of the object models with the aggregate model, and
displaying in one of the difference object models differences between the aggregate model and at least one of the first and second object models.

4. The method of claim 3, further comprising the steps of:
comparing the first object model with the aggregate model, and
displaying in the first difference object model differences between the first object model and the aggregate model.

5. The method of claim 3, further comprising the steps:
comparing the second object model with the aggregate model, and
displaying in the second difference object model differences between the second object model and the aggregate model.

6. The method of claim 2, and further displaying the first difference object model and the second difference object model simultaneously side by side.

7. The method of claim 2, and further displaying similarities between the first object model and the second object model in at least one of the first and second difference object models.

8. The method of claim 1, and further comprising the steps of:
juxtaposing the first object model and the second object model, and
displaying differences between the first object model and the second object model as colors.

9. The method of claim 8, wherein in the juxtaposed first object model and second object model, similar elements in the first object model and second object model are displayed vertically or horizontally at an identical height.

10. The method of claim 1, wherein at least one of a missing element and an additional element is displayed in the first difference object model.

11. The method of claim 2, wherein at least one of a missing element and an additional element is displayed in at least one of the first difference object model and the second difference object model.

12. The method of claim 1, wherein the first difference object model shows at least one of the following differences:
an additional element,
a missing element,
an additional connection,
a missing connection,
an identical parameterization of an element,
a different parameterization of an element, and
a different version of an element.

13. The method of claim 2, wherein the second difference object model shows at least one of the following differences:
an additional element,
a missing element,
an additional connection,
a missing connection,
an identical parameterization of an element,
a different parameterization of an element, and
a different version of an element.

14. The method of claim 2, further comprising the steps of:
generating first XML data from the first object model,
generating second XML data from the second object model,
processing the XML data, and
generating from the processed data the first difference object model and the second difference object model.
